(19) United States
(12) Patent Application Publication
(10) Pub. No.: US 2026/0298164 A1
(43) Pub. Date: Oct. 1, 2026

(54) METHOD FOR EMISSION MANAGEMENT FOR A HYDROGEN VEHICLE

(71) Applicant: PHINIA DELPHI LUXEMBOURG SARL, Belvaux (LU)

(72) Inventor: Gavin DOBER, Luxembourg (LU)

(21) Appl. No.: 19/489,013

(22) PCT Filed: May 23, 2024
(86) PCT No.: PCT/EP2024/064256

§ 371 Date: Dec. 1, 2025

(30) Foreign Application Priority Data
May 30, 2023 (GB) 2308046.8

(51) Int. Cl. F02D 41/00; F02D 41/04

(52) U.S. Cl. CPC F02D 41/0027; F02D 41/042; F02D 2200/0802

(57) ABSTRACT

A method for emission management for a hydrogen vehicle is provided. The vehicle includes a fuel-supply system for supplying hydrogen fuel from a fuel reservoir to a power source of the vehicle when the vehicle is in an operating state. In order to minimize uncontrolled hydrogen emissions from a hydrogen vehicle, the fuel-supply system includes a purgeable portion and the method includes at least the following steps: disconnecting the purgeable portion from the fuel reservoir so that the power source is disconnected from the fuel reservoir, wherein hydrogen fuel remains in the purgeable portion; and performing a purge operation, the purge operation at least including that: hydrogen fuel is discharged from the purgeable portion to reduce a pressure in the purgeable portion to a target pressure; a vent gas is produced inside the vehicle using hydrogen fuel discharged from the purgeable portion, so that the vent gas has a hydrogen concentration below a threshold concentration; and the vent gas is at least partially released into the atmosphere.

### TECHNICAL FIELD

The invention relates to a method for emission management for a hydrogen vehicle and to an emission-management system for a hydrogen vehicle.

### BACKGROUND ART

With the increasing demand to reduce CO₂ emissions from road vehicles, alternatives to traditional internal combustion engines like Diesel or gasoline engines have been developed. Apart from electric vehicles that are powered by batteries, mostly Li-ion batteries, hydrogen-powered vehicles are a promising option. These vehicles fall into two major categories. The first category are hydrogen fuel cell electric (H₂FCE) vehicles, which also have an electric traction motor, but are powered by fuel cells in which the energy of a chemical reaction of hydrogen and oxygen is converted into electric energy. The other category are hydrogen internal combustion engine (H₂ICE) vehicles. In a H₂ICE, hydrogen (H₂) is used as a fuel and burned with oxygen, the reaction product being water.

The hydrogen fuel is stored in one or several hydrogen fuel tanks, which are connected to the engine or the fuel cell(s) by a fuel-supply system, which normally comprises a plurality of pipes, manifolds, and valves. In case of an H₂ICE vehicle, the fuel-supply system may comprise a fuel rail. These components must be filled with hydrogen when the vehicle is operating. When the vehicle is parked, the fuel-supply system is disconnected from the fuel tanks, but unconsumed hydrogen can reside inside the fuel-supply system itself. After some time, hydrogen can leak out, in particular since the hydrogen inside the fuel-supply system typically has a pressure considerably above atmospheric pressure (e.g., in case of a fuel rail between 20 and 40 bar). If the leakage is uncontrolled, the hydrogen—or rather a hydrogen-air mixture—can accumulate in volumes and cavities inside the engine and other parts of the vehicle, which poses an explosion risk, particularly at the restart of the vehicle. Also, it should be borne in mind that hydrogen is considered as a greenhouse gas, wherefore uncontrolled release should be avoided.

### Technical Problem

It is thus an object of the present invention to minimize uncontrolled hydrogen emissions from a hydrogen vehicle.

This problem is solved by a method according to claim 1 and by a system according to claim 15.

### General Description of the Invention

The invention provides a method for emission management for a hydrogen vehicle. The term “hydrogen vehicle” refers to any vehicle that uses hydrogen as a source of energy and is considered synonymous with “hydrogen-powered vehicle”. As a rule, this refers to a road vehicle like a passenger car, a truck, or a motorcycle. However, it is conceivable to employ the inventive fuel-recovery system in other vehicles, e.g., in a boat. Here and in the following, the terms “fuel”, “hydrogen fuel” and “hydrogen” are synonymous. The method realizes an emission management, i.e., emissions from the vehicle are managed or controlled. Specifically, this pertains to hydrogen emissions. While some aspects of the method are implemented by physical or “hardware” components, other aspects may be software-implemented. Although it is conceivable that some aspects (in particular control aspects) of the method could be realized by components outside the hydrogen vehicle, it is preferably entirely performed by using vehicle-integrated components. Control functions of the method may be performed by a control device of the hydrogen vehicle. Such a control device may control various functions and may receive sensor signals.

The vehicle comprises a fuel-supply system for supplying hydrogen fuel from a fuel reservoir to a power source of the vehicle when the vehicle is in an operating state, wherein the fuel-supply system comprises a purgeable portion. In the fuel reservoir, which may comprise one or several fuel tanks, hydrogen fuel is stored either in gaseous form under high pressure or in liquid form. The power source is a device where hydrogen fuel is converted—normally with oxygen—to release energy, which in turn can be used to power various functions of the vehicle, in particular to drive the vehicle. As a rule, the reaction product of the power source is water. The fuel reservoir and the power source are physically connected via the fuel-supply system, which may also be referred to as “fuel supply”. This explicitly includes the possibility that at least one component may be interposed between the fuel-supply system and the fuel reservoir and/or between the fuel-supply system and the power source. In other words, the connection may be indirect. However, the fuel-supply system is at least part of the connection. During operation of the vehicle, the fuel-supply system also establishes a fluid connection between the fuel reservoir and the power source, thereby enabling operation of the power source. The “operating state” is a state in which the power source is operated, hydrogen fuel is consumed, and energy is produced, so that the vehicle moves or at least is ready to move. In a vehicle with an internal combustion engine, this is usually equivalent to an “engine on” state. However, a connection between the fuel reservoir and the engine may also be established in a “key on, engine off” state. This may also be the case e.g., for a vehicle in which the power source is a fuel cell. The fuel-supply system may comprise at least one pipe to conduct the hydrogen fuel, as well as at least one valve, in particular a shut-off valve for controlling the connection to the fuel reservoir. The fuel-supply system comprises a purgeable portion, which includes the possibility that the purgeable portion constitutes the entire fuel-supply system. As the name suggests, this portion can be purged, as will be explained in the following.

In one step of the method, the purgeable portion is disconnected from the fuel reservoir so that the power source is disconnected from the fuel reservoir, wherein hydrogen fuel remains in the purgeable portion. The disconnection refers to a fluid disconnection, while a physical connection remains. As a rule, a shut-off valve is closed to prevent any (significant) fluid exchange between the fuel reservoir and the purgeable portion. This, in turn, results in the power source being disconnected from the fuel reservoir. In other words, disconnecting the purgeable portion of the fuel-supply system separates the connection between the fuel reservoir and the power source. However, although disconnected from the fuel tank(s), the purgeable portion still contains hydrogen fuel. This hydrogen fuel is initially under a high pressure, e.g., over 20 bar(a), wherein “(a)” indicates absolute pressure. The pressure may be different in different parts of the purgeable portion. While the purgeable portion is disconnected from the fuel tank, it may remain connected to the power source. Alternatively, it may also be disconnected from the power source.

In another step of the method, a purge operation is performed. The minimum goal of the purge operation, which will be explained below, is to prevent any hydrogen emissions that could lead to formation of a combustible air-fuel mixture either inside or outside the vehicle. Apart from this, optional goals include a reduction of hydrogen emissions and an improved energy usage. The purge operation comprises the following three steps, which are not necessarily performed in the sequence in which they are mentioned below. In particular, there may be a time overlap between the steps.

One step of the purge operation provides that hydrogen fuel is discharged from the purgeable portion to reduce a pressure in the purgeable portion to a target pressure. In this step, the amount of hydrogen in the fuel-supply system is reduced, which coincides with a reduction of the pressure. The goal is to lower the pressure to a predefined target pressure, or possibly even less. The target pressure is normally not more than 5 bar(a), and may be e.g., 2 bar(a), 1.5 bar(a) or less. The target pressure can preferably be chosen so that any hydrogen leakage from the purgeable portion that could potentially occur cannot lead to the formation of a combustible gas mixture. Also, preferably at least 50%, at least 70%, at least 90% or at least 95% of the hydrogen fuel initially contained in the purgeable portion is discharged. The reduced amount of hydrogen in the purgeable portion means that less hydrogen could escape into the atmosphere in an uncontrolled way. After the transfer, any potential leakage from the purgeable portion cannot (or is unlikely to) lead to a combustible mixture. The hydrogen fuel is discharged or transferred from the purgeable portion, but it is not directly released into the atmosphere. Rather, it is retained inside the vehicle for another step of the purge operation.

In another step of the purge operation, a vent gas is produced inside the vehicle using hydrogen fuel discharged from the purgeable portion, so that the vent gas has a hydrogen concentration below a threshold concentration. Here and in the following, “hydrogen concentration” is used synonymous with “hydrogen-fuel concentration” or “H₂ concentration” and refers to the concentration of elementary hydrogen gas (H₂). The vent gas is a gas mixture. It may comprise a non-negligible concentration of hydrogen fuel, which, however, is below a predefined threshold concentration. The threshold concentration can be defined so that the vent gas can be considered safe, i.e., non-combustible. This is normally guaranteed by a threshold concentration of 4% or less. Under these circumstances, the vent gas does not represent a combustible mixture, even if the oxygen content is high. In most embodiments, the oxygen concentration of the vent gas is similar to air (i.e., about 21%) or lower. In some embodiments, all hydrogen fuel that is discharged from the purgeable portion is used for producing the vent gas, while it is also possible to use only a portion of the discharged hydrogen fuel. Preferably, at least 80% or at least 90% of the discharged hydrogen fuel is used for the vent gas. It should be noted that while all hydrogen used for producing the vent gas is present in the vent gas, it may not be present in elementary form, i.e., not in the form of H₂ gas, but as part of a chemical compound, in particular water (H₂O).

In yet another step of the purge operation, the vent gas is at least partially released into the atmosphere. One could also say that the vent gas is released to the atmosphere around the vehicle. Although it is preferred that the vent gas is released while the vehicle is outdoors, this could also be performed while the vehicle is in a building like an underground parking. To this respect, the inside of a building is also considered as part of “the atmosphere”. Since the vent gas has a hydrogen concentration below the threshold concentration, releasing it can be considered safe by a certain safety criterion. In particular, formation of a combustible mixture outside of the vehicle can be prevented. In some embodiments, the entire amount of vent gas can be released to the atmosphere, while in other embodiments, only a portion is released.

Either way, the inventive method mitigates a possible fire or explosion risk that could originate from hydrogen fuel remaining in the purgeable portion of the fuel-supply system. Once the pressure in the purgeable portion has been lowered to the target pressure, any possible hydrogen leakage from the purgeable portion will not lead to a combustible mixture. Also, such leakage will only release minor amounts of hydrogen into the atmosphere. By producing and releasing the above-described vent gas, the method only gives rise to emissions that can be considered safe under fire-hazard aspects. In certain embodiments, which will be discussed below, the hydrogen content of the emissions is also minimized in consideration of environmental aspects.

The vehicle could be a H₂FCE vehicle, and the power source could be a fuel cell. In this fuel cell, hydrogen and oxygen react to produce water, and the chemical energy is directly converted into electrical energy. This may be used to power an electric drive motor and other electrically operated systems of the vehicle. Another preferred embodiment provides that the power source of the vehicle is a hydrogen internal combustion engine, and the fuel-supply system comprises at least one of a fuel rail assembly and a hydrogen regulation module. The hydrogen internal combustion engine (H₂ICE) is used to burn hydrogen with oxygen, the reaction product being water. It will be understood that since air is used rather than pure oxygen, the combustion may produce minor amounts of other products. As a rule, the H₂ICE has at least one cylinder with an intake valve through which it communicates with an intake duct. A movable piston is disposed in the cylinder, which piston in turn can be connected to a crankshaft. Each cylinder may have an injector for injecting hydrogen fuel directly into the cylinder. Here and in the following, “intake duct” refers to any duct through which the engine and/or at least one cylinder of the engine receives air. Therefore, the term explicitly includes an intake manifold. Normally, the cylinder also has an exhaust valve through which it communicates with an exhaust duct (which term explicitly includes an exhaust manifold). Hydrogen fuel may be directly injected into the respective cylinder. It may also be injected into the intake duct (i.e. upstream of intake valves), corresponding to an indirect injection (e.g. port fuel injection). Both possibilities may be combined. Each injector may be connected to a fuel rail or fuel rail assembly, from which it receives the hydrogen fuel. The fuel rail may be part of the purgeable portion or it may represent the entire purgeable portion. Normally, the fuel rail is not directly connected to the fuel tank(s) but via a hydrogen regulation module (HRM), which may perform several functions. It may comprise a pressure regulator, which reduces the pressure of the hydrogen fuel, e.g., from about 50 bar(a) at the fuel tank to between 20 and 40 bar(a), which is adequate for operation of the fuel rail and the injectors. The HRM may also comprise a filter to remove foreign particles or droplets from the hydrogen fuel. Other elements of the HRM may include a heat exchanger or other heating or cooling device for adjusting the temperature of the fuel. The purgeable portion may comprise at least a part of the HRM. In other embodiments, the purgeable portion (e.g., the fuel rail) may be directly connected to the fuel reservoir without a specific HRM.

There are various options how the vent gas can be produced. One option utilizes the engine to convert hydrogen fuel that is discharged from the purgeable portion. This embodiment provides that in a first purge mode, the vent gas is produced by at least indirectly transferring hydrogen fuel from the purgeable portion to the engine and burning it with oxygen inside the engine. The terms “first”, “second” and “third purge mode” used here and in the following only serve to distinguish various modes and do not imply any sequence or preference. Also, an embodiment of the method could include the second (third) purge mode without including the first (and second) purge mode. In the first purge mode, hydrogen fuel is injected directly into the engine (i.e., into at least one cylinder) and/or into the intake duct. The hydrogen fuel is burned with oxygen to produce water. The resulting gas mixture comprises a significantly reduced or even negligible amount of hydrogen fuel. This vent gas can then be released to the atmosphere through the exhaust duct of the vehicle. It will be understood that the vent gas may contain an increased amount of water resulting from the combustion. Normally, this water remains gaseous until it is released to the atmosphere, but it may also form an aerosol in the vent gas, or it may condense on surfaces inside the vehicle. The first purge mode may use the same injectors that are used during normal operation of the engine. However, at least one dedicated injector could be used for the first purge mode. In this context, it may be relevant that some injectors used during normal operation require a certain minimum pressure to open. During the first purge mode, the pressure in the purgeable portion drops towards the target pressure and may become too low for the normal injectors, thus necessitating dedicated injectors or valves for the purge operation. In the first purge mode, the engine is operated in idle, while it is disconnected from the fuel reservoir. Accordingly, engine operation is normally limited to a few seconds. The first purge mode may be maintained until either the target pressure has been reached or until the hydrogen fuel supplied to the engine becomes insufficient to sustain a stable combustion in the engine. If the latter occurs before the target pressure has been reached, a different purge mode can be entered after the first purge mode.

It is preferred that in the first purge mode, the engine is at least temporarily operated in a low-efficiency mode to increase hydrogen consumption. Such a low-efficiency mode may comprise various measures. For instance, the spark timing may be significantly retarded with respect to the top dead center (TDC). Depending on the engine, this can be done up to a stability limit, which may be e.g., between 50° and 60° after TDC. Another possibility is to employ a small speed acceleration, e.g., up to around 50% above the normal idle speed. Also, it is possible to enrich the fuel-air mixture to maintain a good stability while using a throttle to reduce a lambda value, e.g., from a typical idle value between 2.5 and 3.0 down to between 1.5 and 2.0. Yet another option is to maximize any accessory load, if possible. The low-efficiency mode may be maintained during the entire purge operation. Alternatively, a normal-efficiency mode may be used during the final stage of the purge operation, which may be beneficial when the pressure in the fuel-supply system drops and approaches the target pressure.

In one preferred embodiment, the method comprises the following steps:
receiving a request to deactivate the vehicle while the engine is activated,
disconnecting the purgeable portion from the fuel reservoir,
performing the purge operation in the first purge mode while keeping the engine activated; and
deactivating the engine when the purge operation has been completed.

One could say that in this embodiment, the deactivation of the engine, which is inevitable when the vehicle is deactivated, is delayed until the purge operation has been completed. The request to deactivate the vehicle can also be referred to as a “key-off” request or “ignition-off” request and implies an “engine-off” request. In this context, the key-off request normally indicates that the driver wants to end the journey, or at least pause it for a longer period of time. Therefore, it makes sense to remove a major amount of hydrogen fuel from the purgeable portion to minimize any leakage risk. As the engine is activated (i.e., running) when the request is received, a purge operation in the first purge mode can be carried out immediately. A major part of the hydrogen fuel in the purgeable portion can be converted to water, thereby drastically reducing hydrogen-fuel emissions. Also, the energy produced by the engine during the purge operation can be stored in a battery of the vehicle and will be available when the vehicle is re-activated.

Another embodiment provides that in a second purge mode, the vent gas is produced by mixing hydrogen fuel with an oxygen-containing gas and reacting it with oxygen outside of the engine to produce water. Here and in the following, the term “mixing” does not imply that active mixing needs to be performed, but it also refers to passive mixing. Thus, one could say that hydrogen fuel mixes with oxygen-containing gas. Also, the mixing does not have to result in a homogenous mixture, although this is generally beneficial for the reaction. This embodiment does not employ the engine to convert the hydrogen fuel and can therefore be employed when the engine is deactivated (i.e., stopped). However, the second purge mode may also be used while the engine is activated, optionally even simultaneously with the first purge mode. The second purge mode also relies on a chemical reaction of the hydrogen fuel with oxygen, which produces water. Accordingly, the hydrogen content in the gas mixture can be considerably reduced, even to negligible amounts. The oxygen-containing gas is normally air, but depending on the specific embodiment, it could have a somewhat different composition. E.g., it could comprise exhaust gas from the engine, which has a lower oxygen content than air. Preferably, the gas mixture produced by mixing the hydrogen fuel with the oxygen-containing gas has a hydrogen concentration of at least 2%. Depending on the embodiment, it may beneficially have a hydrogen concentration of up to 10% or up to 30%.

According to a preferred embodiment, hydrogen fuel is reacted with oxygen in the presence of a catalyst. The catalyst, which may also be referred to as an oxidation catalyst, enables or enhances the water-producing reaction between hydrogen and oxygen. The catalyst may e.g., be a platinum-based catalyst. As a rule, the catalyst requires an activation temperature that may be above ambient temperature (typically around 100° C.). Below this activation temperature, the catalyst is ineffective. Also, a certain minimum concentration of hydrogen is necessary for effective operation, e.g., 2%. On the other hand, a certain maximum concentration, e.g., 10%, should not be exceeded, because otherwise the reaction might lead to temperatures that could damage the catalyst. The temperature of the catalyst may depend on the operating time (and other operating conditions) of the vehicle. If the vehicle has only been operated for a short operating time, the temperature could be insufficient. In such a case, the catalyst could be heated with a dedicated electrical heater.

In particular, the hydrogen fuel can be reacted with oxygen in an exhaust duct that comprises the catalyst. In this context, the term “exhaust duct” refers to any vessel that is connected to the engine and receives exhaust gas during the normal operation of the engine. Thus, apart from components that transfer exhaust gas from the engine to the atmosphere, it could also be an EGR (exhaust gas recirculation) duct. The catalyst may be provided as a lining of the exhaust duct (or a portion thereof). When the engine has been in operation for some time, the exhaust duct can be expected to have exceeded the activation temperature of the catalyst. This will also be the case for some time after the engine has been stopped. It is advantageous that the “waste heat” from the exhaust gas, which heats the exhaust duct, can be used to provide the necessary temperature for the catalyst. In this embodiment, the mixing of the hydrogen fuel with the oxygen-containing gas can take place inside the exhaust duct but also at least partially outside (i.e., upstream) of the exhaust duct, e.g., in the engine or even in the intake duct.

According to one embodiment, the method comprises, before the purgeable portion is disconnected from the fuel reservoir, receiving a request to deactivate the engine, and if a catalyst temperature of the catalyst is determined as being below an activation temperature, keeping the engine activated until the activation temperature has been reached. The request to deactivate the engine can also be referred to as an “engine-off” request. This request may be initiated by the driver of the vehicle, or it may be initiated by a start-stop system, which deactivates the engine when it has been idle for, e.g., a few seconds. Irrespective of the origin of the request, the engine is not automatically deactivated, but a catalyst temperature of the catalyst is determined and compared with an above-mentioned activation temperature. It should be noted that the “activation temperature” as referred to in this embodiment may differ from the “actual” activation temperature of the respective catalyst. For instance, the activation temperature that is used for the comparison may be chosen to be higher in order to guarantee that the catalyst is fully activated. The catalyst temperature is determined, which may refer to a direct measurement of the catalyst temperature. Alternatively, it would be possible to measure a temperature of the exhaust duct or any other component that is thermally related to the catalyst. There could even be no temperature measurement at all, and the catalyst temperature could be regarded as being above the activation temperature if the vehicle has been in operation for a specific amount of time. If the catalyst temperature is determined as being below the activation temperature, the engine is kept activated until the activation temperature has been reached. If the catalyst temperature is initially determined as being above (or equal to) the activation temperature, the engine can be deactivated without delay. This embodiment ensures that a purge operation according to the second purge mode can be performed, if necessary.

As an alternative to a catalytic conversion, the hydrogen fuel can be reacted with oxygen by combustion outside of the engine. The main reaction product of the combustion will be water, although some by-products may be produced as well. The combustion takes places outside the engine and insofar is independent of the engine operation. A gas mixture comprising hydrogen fuel and oxygen can be ignited, e.g., by a glow plug or a spark plug. It may be preferred to combust the hydrogen fuel only gradually in order to avoid an explosive combustion. While the abovementioned catalytic reaction usually requires a relatively low hydrogen concentration, combustion can be performed with higher concentrations, e.g., between 8% and 30%. It will be understood that the respective lower and upper limit also depend on the oxygen concentration. The values given here apply if the hydrogen fuel is mixed with air or a gas mixture having a similar oxygen concentration.

The abovementioned first and second purge mode effectively reduce the amount of hydrogen fuel that is released to the atmosphere. While this is preferred, it may be necessary, and also acceptable, to release hydrogen fuel as part of the vent gas while keeping the hydrogen concentration in a safe range. One embodiment provides that in a third purge mode, the vent gas is produced by mixing hydrogen fuel and a diluting gas, preferably air, so that the hydrogen concentration in the resulting mixture is below the threshold concentration. In other words, the vent gas is simply a mixture of hydrogen fuel and a diluting gas. Thus, the hydrogen fuel is simply diluted to a concentration below the threshold concentration. In general, the diluting gas could be any gas that has a hydrogen concentration significantly below the threshold concentration. Preferably, the diluting gas is air, which is introduced into the vehicle to be mixed with the hydrogen fuel. However, its composition could differ from air, e.g., because its oxygen content has been reduced by a combustion process inside the hydrogen vehicle. The mixing takes place in a mixing vessel, into which the diluting gas, specifically air, can be introduced by actively generating a gas flow. The gas flow, preferably air flow, can be generated by various means. It could be generated by the engine, which however leads to a detrimental amount of noise and energy consumption. Alternatively, electrical systems like an e-turbo or e-compressor could be employed. Another option would be to use a separate pump like a crankcase ventilation pump.

There are various options regarding the mixing vessel in which the hydrogen fuel is mixed with the diluting gas. One option is mixing inside the intake duct of the engine. Another option would be the exhaust duct. In these cases, if the exhaust duct comprises the abovementioned oxidation catalyst, it is possible that at least a partial reaction of the hydrogen fuel with the oxygen in the diluting gas occurs, if the catalyst temperature supports such a reaction. In this case, the second and third purge mode are not clearly distinguished. Another option is a dedicated mixing vessel, i.e., a vessel inside the vehicle that is only used for producing the vent gas by mixing. Partially depending on the mixing vessel, it is possible to either control the transfer of the hydrogen fuel through a dedicated purge valve or through an injector that is also used during the normal operation of the engine. The latter may be possible if the engine system is adapted for indirect injection, i.e., if hydrogen fuel from the purgeable portion is injected into the intake duct. In this case, the respective injector can also be used in the third purge mode and the intake duct may serve as a mixing vessel. However, some injectors may only open above a certain minimum pressure, which may be available while the engine is operated and the purgeable portion is connected to the fuel reservoir, but not during the entire purge operation. In this case, the transfer needs to be controlled by a dedicated purge valve that does not require a certain minimum pressure.

In one embodiment, the method comprises receiving a request to deactivate the vehicle while the engine is deactivated, and, if the catalyst temperature of the catalyst is below the activation temperature, performing the purge operation in the third purge mode, and otherwise performing the purge operation in the second purge mode. The request to deactivate the vehicle, which can be referred to as a “key-off” request or “ignition-off” request, is received while the engine is deactivated. The first purge mode would require the engine to be activated again, which is undesirable if a key-off request has already been received. Accordingly, the purge operation may either be performed in the second purge mode or third purge mode. The second purge mode is chosen if the catalyst has already reached the activation temperature and thus can be used to support the hydrogen-oxygen reaction. If the catalyst is below the activation temperature—which is rarely the case if the engine has been in operation for a non-negligible period—the third purge mode is used.

One embodiment provides that after disconnecting the purgeable portion from the fuel reservoir, if the power source is deactivated, a pressure in the purgeable portion is monitored and the purge operation is performed if a pressure drop in the purgeable portion exceeds a tolerance threshold. In a situation where the purgeable portion has been disconnected from the fuel reservoir and the power source (e.g., the engine) has been deactivated, the pressure in the purgeable portion, which is usually still connected to the power source, should remain more or less constant if there is no significant leakage. If, however, hydrogen fuel is leaking from the purgeable portion, the pressure in the purgeable portion will decrease over time. A tolerance threshold can be defined, which accounts for minor, acceptable leakages, measurement error etc. If the pressure drop exceeds the tolerance threshold (which may be, e.g., between 0.5 bar and 2.0 bar), this is interpreted as a significant leakage and a purge operation is performed. It should be noted that calculating the pressure drop may have to take into account the variations in the temperature of the purgeable portion. When the power source is deactivated, the actual pressure in the purgeable portion can be expected to decrease after some time due to a decreasing temperature. Accordingly, a temperature-corrected pressure should be calculated when the pressure drop is determined.

The invention further provides an emission-management system for a hydrogen vehicle, which vehicle comprises a fuel-supply system for supplying hydrogen fuel from a fuel reservoir to a power source of the vehicle when the vehicle is in an operating state, the fuel-supply system comprising a purgeable portion, wherein the emission-management system is configured to perform at least the following steps:
disconnecting the purgeable portion from the fuel reservoir so that the power source is disconnected from the fuel reservoir, wherein hydrogen fuel remains in the purgeable portion; and
performing a purge operation,
   the purge operation at least comprising that:
hydrogen fuel is discharged from the purgeable portion to reduce a pressure in the purgeable portion to a target pressure;
a vent gas is produced inside the vehicle using hydrogen fuel discharged from the purgeable portion, so that the vent gas has a hydrogen concentration below a threshold concentration; and
the vent gas is at least partially released into the atmosphere.

All these terms have been explained above with respect to the inventive method and therefore will not be explained again. Preferred embodiments of the inventive emission-management system correspond to those of the inventive method.

### BRIEF DESCRIPTION OF THE DRAWINGS

Preferred embodiments of the invention will now be described, by way of example, with reference to the accompanying drawings, in which:

FIG. 1 is a schematic view of components of a hydrogen vehicle with an emission-management system according to a first embodiment of the present invention;

FIG. 2 is a schematic view of components of a hydrogen vehicle with an emission-management system according to a second embodiment of the present invention;

FIG. 3 is a schematic view of components of a hydrogen vehicle with an emission-management system according to a third embodiment of the present invention; and

FIG. 4 is a flowchart illustrating a method for emission management according to the present invention.

### DESCRIPTION OF PREFERRED EMBODIMENTS

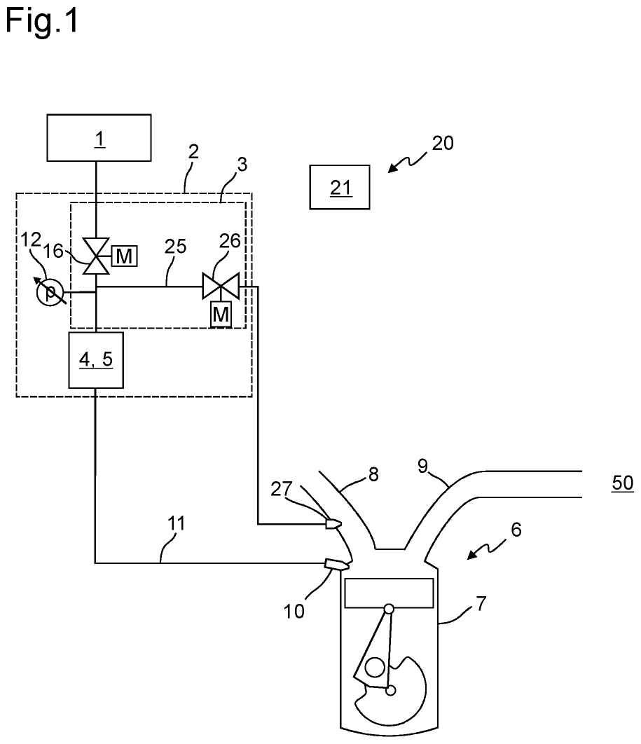

FIG. 1 shows a schematic view of some elements of a hydrogen vehicle, more specifically an H₂ICE vehicle, with a first embodiment of an inventive emission-management system 20. The vehicle comprises a hydrogen internal combustion engine 6, which is shown in a highly simplified form with only a single cylinder 7 visible. The engine 6 is connected to an intake duct 8 (normally comprising an intake manifold) and an exhaust duct 9 (normally comprising an exhaust manifold). For each cylinder 7, an injector 10 is arranged to inject hydrogen fuel directly into a cylinder head, whereas an end piece 27 of a purge line 25 is arranged to inject hydrogen fuel into the intake duct 8, which corresponds to an indirect injection into the engine 6. The end piece 27 can be a nozzle, a controllable injector or can simply be the end of a pipe. The engine 6 represents a power source of the vehicle, in which hydrogen is burned with oxygen to convert chemical energy into mechanical energy. The mechanical energy is used to drive the vehicle and may also be converted through a generator (not shown) into electrical energy.

The hydrogen fuel needed to supply the engine 6 is stored in a fuel reservoir 1, which comprises at least one highly pressure-resistant fuel tank. Inside the fuel reservoir 1, the pressure may be several hundred bar(a), e.g., up to 700 bar(a). The fuel reservoir 1 is connected to the engine 6 via a fuel-supply system 2, which comprises a hydrogen regulation module (HRM) 3 and a fuel rail assembly or fuel rail 5, which are only shown schematically. The fuel reservoir 1 typically includes a regulator valve configured to deliver hydrogen fuel to the fuel-supply system 2 at a pressure of about 50 bar(a). The HRM 2 may comprise various elements, like a pressure regulator, which reduces the pressure of the hydrogen fuel, e.g., from about 50 bar(a) to between 20 and 40 bar(a), a filter to remove foreign particles or droplets from the hydrogen fuel, a heating or cooling device for adjusting the temperature of the hydrogen fuel etc. In this embodiment, the fuel rail 5 represents a purgeable portion 4 of the fuel-supply system 2, while in other embodiments, the purgeable portion 4 may only be a part of the fuel rail 5 and/or may also comprise at least a part of the HRM 3. The fuel rail 5 is connected to the injector 10 via an injector line 11 but could alternatively be directly connected to the injector 10. On its upstream side, the fuel rail 5 is connected to the HRM 3. The HRM 3 comprises a shut-off valve 16 by which the purgeable portion 4 (i.e., the fuel rail 5) and the engine 6 can be disconnected from the fuel reservoir 1.

While the vehicle is in an operating state, hydrogen fuel is supplied to the injector 10 and the shut-off valve 16 is open. When the vehicle enters a non-operating state in which the engine 6 is turned off, the shut-off valve 16 is closed so that the fuel rail 5 is isolated from the fuel reservoir 1. However, a considerable amount of hydrogen fuel still resides in the purgeable portion 4, i.e., the fuel rail 5, and is still under considerable pressure, which is typically above 10 bar(a), e.g., between 20 and 40 bar(a).

The function of the emission-management system 20 is to mitigate an explosion risk originating from hydrogen fuel leaking out of the purgeable portion 4 into the engine 6, into other parts of the vehicle, or into the atmosphere 50 around the vehicle. In the embodiment shown in FIG. 1, the emission-management system 20 comprises a control device 21, which controls a purge valve 26 in the purge line 25. The purge line 25 connects the purgeable portion 4 to the intake duct 8. A pressure sensor 12 is arranged to measure a pressure in the purgeable portion 4 and transmits measurement values to the control device 21.

While the vehicle is in its operating state, the control device 21 keeps the purge valve 26 closed. In case of a request to deactivate the vehicle, the shut-off valve 16 is closed, whereby the purgeable portion 4 is separated from the fuel reservoir 1. The control device 21 may either control the shut-off valve 16 itself or may at least receive a signal that indicates the request to deactivate the vehicle. Before the engine 6 is deactivated, a purge operation is performed, in this case according to a first purge mode. This first purge mode provides that hydrogen fuel residing in the purgeable portion 4 is reacted in the engine after the purgeable portion 4 has been separated from the fuel reservoir 1. Accordingly, the engine 6 is kept in operation until at least a major part of the hydrogen fuel has been consumed. The purge operation is performed until the pressure in the purgeable portion 4 has reached a target pressure of, e.g., 1.5 bar(a). In the embodiment shown, the injector 10 requires a certain minimum pressure to open, wherefore it cannot be used to inject hydrogen fuel during the entire purge operation. The purge valve 26, on the other hand, can be opened even at low pressures. Accordingly, the control device 21 can either use the purge line 25 during the entire purge operation, or it may use the injector line 11 and the injector 10 while the pressure is high enough.

During the purge operation, the engine may at least temporarily be operated in a low-efficiency mode to increase hydrogen consumption. Such a low-efficiency mode may comprise various measures. For instance, the spark timing may be significantly retarded with respect to the top dead center (TDC), e.g., up to a stability limit which may be between 50° and 60° after TDC. Another possibility is to employ a small speed acceleration, e.g., up to around 50% above the normal idle speed. Also, it is possible to enrich the fuel-air mixture to maintain a good stability while using a throttle to reduce a lambda value, e.g., from a typical idle value between 2.5 and 3.0 down to between 1.5 and 2.0. These measures may be controlled by the control device 21, which monitors the pressure in the purgeable portion 4 and terminates the purge operation when the target pressure has been reached. During the final stage of the purge operation, when the pressure in the purgeable portion 4 drops and approaches the target pressure, the engine 6 may be operated in a normal-efficiency mode. The operation of the engine 6 corresponds to a reaction of the hydrogen fuel with oxygen that produces water. The resulting gas mixture represents a vent gas with negligible hydrogen concentration. Specifically, the hydrogen concentration is much lower than a threshold concentration of e.g., 4%. Any gas mixture with a lower hydrogen concentration cannot form a combustible mixture outside the vehicle. Accordingly, the vent gas can be released to the atmosphere 50 without any concern. Also, since the vent gas contains only minor amounts of hydrogen fuel, it can be considered unproblematic under environmental aspects.

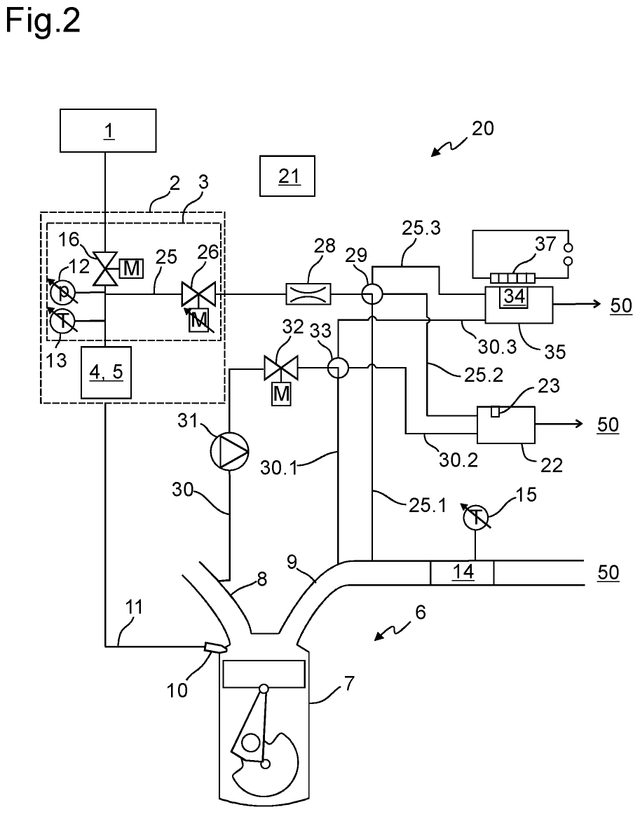

FIG. 2 shows a second embodiment of an inventive emission-management system 20. Many of the components are identical to the first embodiment and thus will not be explained again. In this embodiment, the purge line 25 comprises three branches 25.1-25.3, which are connected by a first directional valve 29. Also, an orifice 28 is disposed in the purge line 25 between the purge valve 26 and the first directional valve 29. An air-supply line 30 is connected to the intake duct 8 but could alternatively be connected to a crankcase of the engine 6 or directly to the atmosphere 50. It comprises a pump 31 (which may be a crankcase ventilation pump) and an air-supply valve 32. It further comprises three branches 30.1-30.3, which are connected by a second directional valve 33. The first branches 25.1 30.1 of the air-supply line 30 and the purge line 25 are connected to the exhaust duct 9, which in this case comprises a first catalyst 14, specifically an oxidation catalyst that may be platinum-based. The second branches 25.2, 30.2 are connected to a combustion chamber 22 in which a spark plug 23 is disposed. Alternatively, a glow plug could also be used. The combustion chamber 22 communicates with the atmosphere 50. The third branches 25.3, 30.3 are connected to a catalyst chamber 35 which also comprises a second catalyst 34 that can be heated by an electrical heater 37. Although the catalysts 14, 34 are provided in different locations, they may be of the same type, e.g., both may be platinum-based catalysts.

In this embodiment, when the engine 6 has been deactivated and the purgeable portion 4 has been separated from the fuel reservoir 1 by closing the shut-off valve 16, the control device 21 can monitor the pressure in the purgeable portion 4 using the pressure sensor 12. Also, it may use a temperature sensor 13 to monitor the temperature in the purgeable portion 4 in order to apply a temperature correction to the current pressure measurement. If a pressure drop (after temperature correction) exceeds a predefined tolerance threshold (e.g., 1 bar), this is interpreted as an excessive leakage from the purgeable portion 4, wherefore the control device 21 initiates a purge operation according to a second purge mode. In this example, there are three options how the purge operation can be carried out depending on the setting of the directional valves 29, 23. While these three options are shown here for illustrative purposes, it is more realistic that only one option is available, i.e., the purge line 25 and the air-supply line 30 would each only comprise a single branch.

FIG. 2 shows the purge line 25 and the air-supply line 30 connected to their respective first branches 25.1, 30.1. Accordingly, when the purge valve 26 and the air supply valve 32 are opened, hydrogen fuel and air are transferred into the exhaust duct 9 where they mix and pass over the first catalyst 14. If a catalyst temperature of the first catalyst 14 has at least reached an activation temperature (e.g., 100° C.), as can be verified via another temperature sensor 15, hydrogen fuel and oxygen are catalytically converted to water. The resulting vent gas from this reaction has a hydrogen concentration that is significantly below the threshold concentration of 4% and can be vented to the atmosphere 50. By a different setting of the directional valves 29, 33, the second branches 25.2, 30.2 can be activated so that the purge line 25 and the air-supply line 30 are connected to the combustion chamber 22. When the purge valve 26 and the air-supply valve 32 are opened, hydrogen fuel and air enter the combustion chamber 22 where they form a mixture that can be ignited by the spark plug 23, whereby water is formed. The resulting gas mixture is a vent gas also with a low hydrogen concentration that is safe for release to the atmosphere 50. By yet another setting of the directional valves 29, 33, the third branches 25.3, 30.3 can be activated so that the purge line 25 and the air-supply line 30 are connected to the catalyst chamber 35. The reaction over the second catalyst 34 corresponds to the one over the catalyst 14. Since the catalyst 34 is electrically heated, it can always be assumed to have at least the activation temperature. Again, a vent gas is formed that has a hydrogen concentration well below the threshold concentration and can be released to the atmosphere 50.

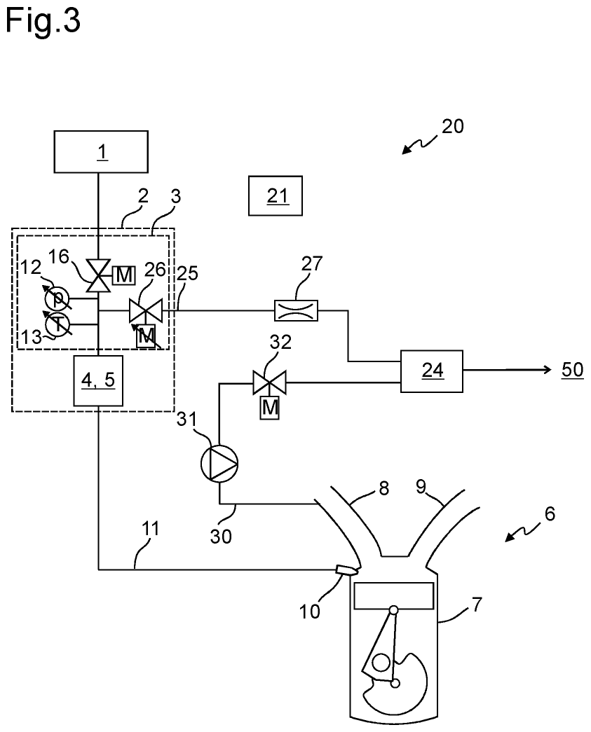

FIG. 3 shows a third embodiment of an inventive emission-management system 20. Many of the components are identical to the first and second embodiment and thus will not be explained again. In this embodiment, the purge line 25 and the air-supply line 30 are unbranched and are connected to a mixing vessel 24. Again, the control device 21 can initiate a purge operation, in this case according to a third purge mode, depending on a pressure drop in the purgeable portion 4. When the purge valve 26 and the supply valve 32 are opened, hydrogen fuel and air form a mixture in the mixing vessel 24, which mixture represents a vent gas. The air flow through the air-supply line 30 and the hydrogen flow through the purge valve 25 are adjusted in relation to each other so that the vent gas has a hydrogen concentration below the threshold concentration. Accordingly, the vent gas can be released to the atmosphere 50. Alternatively to using a dedicated mixing vessel 24, the mixing could also take place in the intake duct 8 or the outlet duct 9.

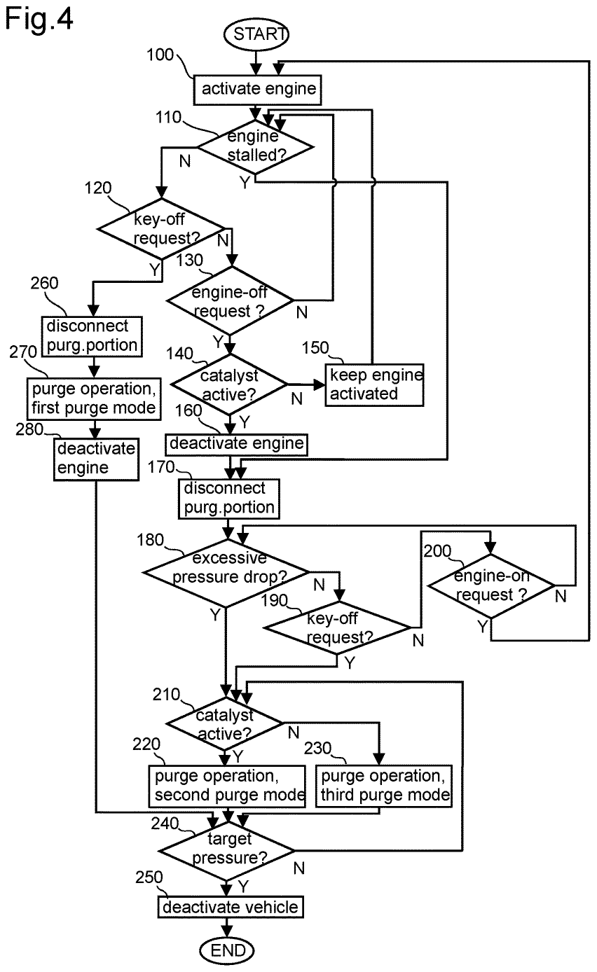

For sake of clarity, the embodiments shown in FIGS. 1-3 are shown separately, so that each emission-management system 20 is only adapted for a single purge mode. However, features of these three embodiments can be combined in a single system 20, which is adapted for all three purge modes, depending on the situation. Operation of such an emission-management system 20 will now be explained with reference to FIG. 4, which is a flowchart of an inventive method for emission management.

In a first step, at 100, the engine 6 of the vehicle is activated. At 110, it is checked whether the engine has stalled. If not, a check is performed at 120 if there is a key-off request, which corresponds to the vehicle being deactivated, e.g., at the end of a journey. If not, a check is performed at 130 whether there is an engine-off request. Such a request may be initiated by the driver or by a start-stop system. If there is no such request, the method returns to step 110. If there is an engine-off request, a check is performed at 140 whether the (first) catalyst 14 is active, i.e., whether the catalyst temperature is above the activation temperature. If not, the engine 6 is kept activated at 150 and the method returns to 110. After some time, the catalyst 14 will have reached its activation temperature and the method can continue, at step 160 by deactivating the engine 6 (corresponding to “engine off”) and at step 170, the purgeable portion 5 is disconnected from the fuel reservoir 1.

At step 180, a check is performed if the pressure drop in the purgeable portion 4 is excessive, i.e., if it exceeds the tolerance threshold. If not, it is checked at 190 if there is a key-off request, corresponding to the driver ending the journey. If not, it is checked at 200 if there is an engine-on request. Again, such a request may be either initiated by the driver or by the start-stop system. If so, the method returns to step 100 where the engine 6 is started. If not, it returns to step 180. If the tolerance threshold is exceeded, or if there is a key-off request, a purge operation is performed. Since the engine 6 is not available, only the second or third purge mode are possible at this time. At 210, it is checked again whether the catalyst 14 is active. If so, a purge operation according to the second purge mode is performed at 220, whereafter it is checked at 240 if the pressure in the purgeable portion 4 is at or below the target pressure. If so, the vehicle is deactivated (corresponding to “key off”) at step 250, and the method ends. If the pressure is still above the target pressure, the method returns to 210. If the catalyst 14 is not active, a purge operation according to the third purge mode is performed at 230 before the pressure is checked at 240. Depending on the check result, the method either returns to 210, or the vehicle is deactivated at 250, and the method ends.

If, at step 110, it is found that the engine 6 is stalled, the method immediately jumps to step 170 and continues as already described. If, at step 120, it is found that a key-off request has been received, the purgeable portion 4 is disconnected at 260 before a purge operation according to the first purge mode is performed at 270, whereafter the engine is deactivated at 280. After that, the pressure is checked at 240 and the vehicle may be deactivated at 250 before the method ends. If, however, the target pressure has not been reached, the method cannot re-enter the first purge mode because the engine is already deactivated. It therefore continues with step 210 and may complete the purging either in the second purge mode or in the third purge mode.

Legend of reference numbers:

| | |
|---|---|
| 1 | fuel reservoir |
| 2 | fuel-supply system |
| 3 | HRM |
| 4 | Purgeable portion |
| 5 | fuel rail |
| 6 | engine |
| 7 | cylinder |
| 8 | intake duct |
| 9 | exhaust duct |
| 10 | injector |
| 11 | injector line |
| 12 | pressure sensor |
| 13, 15 | temperature sensor |
| 14, 34 | catalyst |
| 16 | shut-off valve |
| 20 | emission-management system |
| 21 | control device |
| 22 | combustion chamber |
| 23 | spark plug |
| 25 | purge line |
| 25.1-25.3 | branch |
| 26 | purge valve |
| 27 | end piece |
| 28 | orifice |
| 29, 33 | directional valve |
| 30 | air-supply line |
| 30.1-30.3 | branch |
| 31 | pump |
| 32 | air-supply valve |
| 35 | catalyst chamber |
| 37 | electrical heater |
| 50 | atmosphere |

1. A method for emission management for a hydrogen vehicle, which vehicle comprises a fuel-supply system for supplying hydrogen fuel from a fuel reservoir to a power source of the vehicle when the vehicle is in an operating state, the fuel-supply system comprising a purgeable portion, wherein the method comprises at least the following steps:
disconnecting the purgeable portion of the fuel-supply system from the fuel reservoir so that the power source is disconnected from the fuel reservoir, wherein hydrogen fuel remains in the purgeable portion; and
performing a purge operation,
the purge operation at least comprising that:
hydrogen fuel is discharged from the purgeable portion to reduce a pressure in the purgeable portion to a target pressure;
a vent gas is produced inside the vehicle using hydrogen fuel discharged from the purgeable portion, so that the vent gas has a hydrogen concentration below a threshold concentration; and
the vent gas is at least partially released into the atmosphere.

2. The method according to claim 1, wherein the power source of the vehicle is a hydrogen internal combustion engine, and the fuel-supply system comprises at least one of a fuel rail assembly and a hydrogen regulation module.

3. The method according to claim 1, wherein in a first purge mode, the vent gas is produced by at least indirectly transferring hydrogen fuel from the purgeable portion to the engine and burning it with oxygen inside the engine.

4. The method according to claim 3, wherein in the first purge mode, the engine is at least temporarily operated in a low-efficiency mode to increase hydrogen consumption.

5. The method according to claim 3, comprising,
receiving a request to deactivate the vehicle while the engine is activated;
disconnecting the purgeable portion from the fuel reservoir;
performing the purge operation in the first purge mode while keeping the engine activated; and
deactivating the engine when the purge operation has been completed.

6. The method according to claim 3, wherein in a second purge mode, the vent gas is produced by mixing hydrogen fuel with an oxygen-containing gas and reacting it with oxygen outside of the engine to produce water.

7. The method according to claim 6, wherein hydrogen fuel is reacted with oxygen in the presence of a catalyst.

8. The method according to claim 7, wherein the hydrogen fuel is reacted with oxygen in an exhaust duct that comprises the catalyst.

9. The method according to claim 7, comprising, before the purgeable portion is disconnected from the fuel reservoir:
receiving a request to deactivate the engine; and
if a catalyst temperature of the catalyst is determined as being below an activation temperature, keeping the engine activated until the activation temperature has been reached.

10. The method according to claim 6, wherein the hydrogen fuel is reacted with oxygen by combustion outside of the engine.

11. The method according to claim 6, wherein in a third purge mode, the vent gas is produced by mixing hydrogen fuel and a diluting gas so that the hydrogen concentration in the resulting mixture is below the threshold concentration.

12. The method according to claim 11, wherein the hydrogen is mixed with the diluting gas inside an intake duct of the engine, an exhaust duct of the engine, or a dedicated mixing vessel.

13. The method according to claim 11, comprising:
receiving a request to deactivate the vehicle while the engine is deactivated; and
if the catalyst temperature of the catalyst is below the activation temperature, performing the purge operation in the third purge mode, and otherwise performing the purge operation in the second purge mode.

14. The method according to claim 1, wherein, after disconnecting the purgeable portion from the fuel reservoir, if the power source is deactivated, a pressure in the purgeable portion is monitored and the purge operation is performed if a pressure drop in the purgeable portion exceeds a tolerance threshold.

15. A system for emission management for a hydrogen vehicle, which vehicle comprises a fuel-supply system for supplying hydrogen fuel from a fuel reservoir to a power source of the vehicle when the vehicle is in an operating state, the fuel-supply system comprising a purgeable portion, wherein the system is configured to perform at least the following steps:
disconnecting the purgeable portion from the fuel reservoir so that the power source is disconnected from the fuel reservoir, wherein hydrogen fuel remains in the purgeable portion, and
performing a purge operation,
the purge operation at least comprising that:
hydrogen fuel is discharged from the purgeable portion to reduce a pressure in the purgeable portion to a target pressure;
a vent gas is produced inside the vehicle using hydrogen fuel discharged from the purgeable portion, so that the vent gas has a hydrogen concentration below a threshold concentration; and
the vent gas is at least partially released into the atmosphere.

16. The method according to claim 11, wherein the diluting gas is air.
